(19) United States
(12) Patent Application Publication
(10) Pub. No.: US 2023/0110452 A1
(43) Pub. Date: Apr. 13, 2023

(54) METHOD OF PREPARING SUPPLEMENTARY CEMENTITIOUS MATERIALS, AND SUPPLEMENTARY CEMENTITIOUS MATERIALS PREPARED THEREFROM

(71) Applicant: Solidia Technologies, Inc., Piscataway, NJ (US)

(72) Inventors: Vahit Atakan, West Windsor, NJ (US); Mario Jorge Davidson, Somerset, NJ (US); Sadananda Sahu, Tallahassee, FL (US)

(21) Appl. No.: 17/961,427

(22) Filed: Oct. 6, 2022

Related U.S. Application Data
(60) Provisional application No. 63/253,343, filed on Oct. 7, 2021.

(51) Int. Cl. C04B 20/02; C04B 14/04; C04B 28/04

(52) U.S. Cl. CPC C04B 20/023; C04B 20/026; C04B 14/043; C04B 28/04

(57) ABSTRACT

A method of preparing a carbonated supplementary cementitious materials, includes carbonating the carbonatable mixture to obtain a first carbonated cementitious material, milling the first carbonated cementitious material, and carbonating the milled mixture to obtain the carbonated supplementary cementitious material.

### CROSS-REFERENCE TO RELATED APPLICATION(S)

This application claims the benefit of priority pursuant to 35 U.S.C. § 119(e) to U.S. provisional Application No. 63/253,343 filed Oct. 7, 2021, the entire contents of which are incorporated by reference as if fully set forth herein.

### FIELD

The present application is directed to the preparation of ground carbonated supplementary cementitious materials having enhanced carbon dioxide uptake.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions, or is known to be relevant to an attempt to solve any problem with which this specification is concerned.

The production of ordinary Portland cement (OPC) is a very energy-intensive process and a major contributor to greenhouse gas emissions. The cement sector is the third largest industrial energy consumer and the second largest CO₂ emitter of total industrial CO₂ emissions. World cement production reached 4.1 Gt in 2019 and is estimated to contribute about 8% of total anthropogenic CO₂ emissions.

In an attempt to combat climate change, the members of the United Nations Framework Convention on Climate Change (UNFCC), through the Paris Agreement adopted in December 2015, agreed to reduce CO₂ emissions by 20% to 25% in 2030. This represents an annual reduction of 1 giga ton CO₂. Under this agreement, the UNFCC agreed to keep the global temperature rise within 2° C. by the end of this century. To achieve this goal, the World Business Council for Sustainable Development (WBCSD) Cement Sustainability Initiative (CSI) developed a roadmap called “Low-Carbon Transition in Cement Industry” (WBCSD-CSI). This roadmap identified four carbon emissions reduction levers for the global cement industry. The first lever is improving energy efficiency by retrofitting existing facilities to improve energy performance. The second is switching to alternative fuels that are less carbon intensive. For example, biomass and waste materials can be used in cement kilns to offset the consumption of carbon-intensive fossil fuels. Third is reduction of clinker factor or the clinker to cement ratio. Lastly, the WBCSD-CSI suggests using emerging and innovative technologies, such as integrating carbon capture into the cement manufacturing process.

Thus, there is a need for improved cement production that reduces CO₂ emissions; reducing the global effect of climate change. The present disclosure attempts to address these problems, as identified by the EPA and the UNFCC, by developing a method of integrating carbon capture into the cement manufacturing process.

For instance, Solidia Technologies Inc. has developed a low CO₂ emissions clinker that reduces CO₂ emissions by 30%. However, a need exists to integrate such materials into conventional hydraulic concrete materials to reduce the clinker factor in hydraulic cements such as ordinary Portland cement (OPC), and to further boost the positive environmental potential through the use of such low CO₂ emissions materials as supplementary cementitious materials (SCM) in concrete. While certain aspects of conventional technologies have been discussed to facilitate disclosure of the invention, Applicant in no way disclaims these technical aspects, and it is contemplated that the claimed invention may encompass or include one or more of the conventional technical aspects discussed herein.

### SUMMARY

It has been discovered that the above-noted deficiencies can be addressed, and certain advantages attained, by the present invention. For example, the methods and compositions of the present invention provide a novel approach to pre-carbonate a carbonatable clinker, preferably but not exclusively a low CO₂ emission clinker, before adding it to a hydraulic cement as a supplementary cementitious material (SCM), thereby both reducing the clinker factor of conventional hydraulic cements, and incorporating carbon capture into the production of the cement or concrete material, thus providing a doubly positive environmental benefit. Various exemplary methods for preparing the SCM, including a slurry process, a cyclic carbonation process, a non-slurry carbonation process (semi-wet carbonation process) and a high temperature carbonation process, are described in U.S. provisional application Nos. 63/151,971 and 63/217,590, and in corresponding U.S. application Ser. Nos. 17/675,777 and 17/855,576, respectively, the contents of which are incorporated by reference as if fully set forth herein.

An exemplary embodiment is directed to a method of preparing a carbonated supplementary cementitious material, the method comprising: adding water to a carbonatable material to form a carbonatable mixture, wherein a moisture content of the carbonatable mixture is from about 0.1% to about 99.9%; agitating or stirring the carbonatable mixture for about 1 minute to 24 hours; carbonating the carbonatable mixture to obtain a first carbonated cementitious material; milling the first carbonated cementitious material for about 0.1 minute to about 60 minutes to obtain a milled mixture; and carbonating the milled mixture for about 1 minute to about 24 hours, wherein carbonating the carbonatable mixture and the milled mixture comprises flowing a gas comprising about 5% to about 100% carbon dioxide, by volume, respectively, and maintaining a temperature of about 1° C. to about 99° C., to obtain the carbonated supplementary cementitious material. The carbonation and milling steps can optionally be repeated up to 10 times to maximize the uptake of CO₂.

Another exemplary embodiment is directed to a method for forming cement or concrete, the method comprising: forming a carbonated supplementary cementitious material according to any of the methods described herein; combining the carbonated supplementary cementitious material with a hydraulic cement composition to form a cementitious material mixture, wherein the cementitious material mixture comprises about 1% to about 99%, by weight, of the carbonated supplementary cementitious material, based on the total weight of solids in the mixture; and reacting the cementitious material mixture with water to form the cement or concrete.

### BRIEF DESCRIPTION OF THE DRAWINGS

These and other features of this invention will now be described with reference to the drawings of certain embodiments which are intended to illustrate and not to limit the invention.

FIG. 1 represents the measurement of the mortar flow of a mixture of ASTM sand conforming to ASTM C778 and supplementary cementitious material prepared using a grinding method according to an exemplary embodiment, measured at 20% replacement of ordinary Portland cement (OPC) having a water to cement ratio (w/c) of 0.485.

FIG. 2 represents the SAI of a milled supplementary cementitious material according to an exemplary embodiment, measured at 20% replacement of OPC having a w/c of 0.485, after 7 days and 28 days, respectively.

FIG. 3 represents the CO₂ uptake of the working and comparative Examples of this application.

### DETAILED DESCRIPTION

Further aspects, features and advantages of this invention will become apparent from the detailed description which follows. It should be understood that the various individual aspects and features of the present invention described herein can be combined with any one or more individual aspect or feature, in any number, to form embodiments of the present invention that are specifically contemplated and encompassed by the present invention. Furthermore, any of the features recited in the claims can be combined with any of the other features recited in the claims, in any number or in any combination thereof. Such combinations are also expressly contemplated as being encompassed by the present invention.

As used herein, the singular forms “a”, “an” and “the” are intended to include the plural forms as well, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

Unless indicated otherwise, each of the individual features or embodiments of the present specification are combinable with any other individual feature or embodiment that are described herein, without limitation. Such combinations are specifically contemplated as being within the scope of the present invention, regardless of whether they are explicitly described as a combination herein.

Technical and scientific terms used herein have the meaning commonly understood by one of skill in the art to which the present description pertains, unless otherwise defined. Reference is made herein to various methodologies and materials known to those of skill in the art.

The base material used to form the supplementary cementitious materials of the present invention is not particularly limited so long as it is carbonatable. As used herein, the term “carbonatable” means a material that can react with and sequester carbon dioxide under the conditions described herein, or comparable conditions. The carbonatable material can be a naturally occurring material, or may be synthesized from precursor materials.

In an exemplary embodiment, the carbonatable material can include Municipal Solid Waste (MSW). As used herein, MSW is defined as waste materials generated by homes or businesses, including, for example, food, kitchen waste, green waste, paper waste, glass, bottles, cans, metals, plastics, fabrics, clothes, batteries, tires, building debris, construction and demolition waste, dirt, rocks, debris, electronic appliances, computer equipment, paints, chemicals, light bulbs and fluorescent lights, fertilizers, and medical waste. As defined in the invention, MSW also includes sewage sludge, which contains undigested food residues, mucus, bacteria, urea, chloride, sodium ions, potassium ions, creatinine, other dissolved ions, inorganic and organic compounds and water. MSW in its various forms contains CO₂ and water in more concentrated form than pure water and carbon dioxide. For example, the carbon content of municipal solid waste in 1 large dumpster is equivalent to at least 15,000 pounds of carbon dioxide and 700 gallons of water. Unlike pure water and CO₂, neither refrigeration nor preservatives are needed to store municipal solid waste over the long term. Furthermore, minimal transportation is required to bring municipal solid waste to a decomposition site.

An exemplary embodiment of this application is directed to a method of preparing a carbonated supplementary cementitious material, the method comprising: adding water to a carbonatable material to form a carbonatable mixture, wherein a moisture content of the mixture is from about 0.1% to about 99.99% by weight; agitating or stirring the carbonatable mixture for about 1 minute to 24 hours; carbonating the carbonatable mixture to obtain a first carbonated cementitious material; milling the first carbonated cementitious material for about 0.1 minute to about 10 minutes to obtain a milled mixture; and carbonating the milled mixture for about 1 minute to about 24 hours by flowing a gas comprising about 5% to about 100% carbon dioxide, by volume, carbon dioxide into the mixture and the milled mixture, respectively, and maintaining a temperature of about 1° C. to about 99° C., to obtain the carbonated supplementary cementitious material.

The carbonatable material may include a moisture content in an amount from about 0.1% to about 99.99%, from about 0.1% to about 90%, about 0.1% to about 80%, about 0.1% to about 70%, from about 0.1%, from about 0.1% to about 50%, from about 0.1% to about 40%, from about 0.1% to about 30%, from about 0.1% to about 20%, from about 0.1% to about 10%, and the like, and having any values falling within any of these enumerated ranges, such as 0.1%, 1.0%, 0.5% to 10%, 0.5% to 90%, 10.5%, 6.75% to 9.25%, and the like. The value of the moisture content can be equal to any integer value or values within any of the above-described numerical ranges, including the end-points of the range.

The carbonatable mixture may be agitated or stirred for about 1 minute to about 15 hours, about 5 minutes to about 14 hours, about 10 minutes to about 13 hours, about 15 minutes to about 12 hours, about 20 minutes to about 11 hours, about 30 minutes to about 10 hours, about 1 hour to about 9.5 hours, about 1.5 hours to about 8 hours, about 2 hours to about 7.5 hours, about 2.5 hours to about 7 hours, about 3 hours to about 6.5 hours, about 3.5 hours to about 6 hours, about 4 hours to about 5.5 hours, about 4.5 hours to about 5 hours, and the like. The time of agitating or stirring can be equal to any integer value or values within any of the above-described numerical ranges, including the end-points of these ranges.

The order of the various steps of the above-described method is not particularly limited, and the agitating or stirring and the carbonating may be carried out simultaneously or the agitating or stirring and the carbonating may be carried out successively.

In an exemplary embodiment, the method described herein further comprises a plurality of carbonation cycles alternating with a plurality of milling cycles. The time for each of the plurality of carbonation cycles and each of the plurality of milling cycles can be as described in this application.

In another exemplary embodiment, the process can further comprise steaming the milled mixture prior to carbonating the milled mixture, wherein the steaming comprises exposing the milled mixture to water vapor or steam at a temperature of about 20° C. to about 200° C., about 40° C. to about 180° C., about 60° C. to about 160° C., about 80° C. to about 140° C., about 100° C. to about 120° C., and the like. The temperature can be equal to any integer value or values within any of the above-described numerical ranges, including the end-points of these ranges. The steaming of the milled mixture can be carried out simultaneously with carbonating the milled mixture or can be carried out before carbonating the milled mixture, and a plurality of steaming steps may be used in conjunction with a plurality of milling steps.

In another exemplary embodiment, the process can further comprise: drying the carbonated supplementary cementitious material for about 5 to about 25 hours, for about 5 hours to about 24 hours, for about 6 hours to about 24 hours, and the like, at a temperature of about 50° C. to about 150° C., about 53° C. to about 140° C., about 56° C. to about 130° C., about 60° C. to about 120° C., and the like; and/or spreading out the carbonatable mixture in a layer having a thickness of about 0.05 inches to about 1.5 inches, about 0.1 inch to about 1 inch, about 0.15 inches to about 0.95 inches, about 0.2 inches to about 0.9 inches, about 0.25 inches to about 0.85 inches, about 0.3 inches to about 0.8 inches, about 0.35 inches to about 0.75 inches, about 0.4 inches to about 0.7 inches, about 0.45 inches to about 0.65 inches, about 0.5 inches to about 0.6 inches, and the like, prior to exposing the carbonatable mixture to a carbonation cycle; and/or de-agglomerating the mixture; and/or re-wetting and agitating or stirring the carbonatable mixture after each of the plurality of carbonation cycles; and/or a plurality of milling cycles of the carbonated supplementary cementitious material; and/or moistening the gas comprising carbon dioxide prior to feeding the gas during the plurality of carbonation cycles, wherein moistening the gas comprises bubbling the gas through hot water. The values of the above-described numerical ranges can be equal to any integer value or values within any of the above-described numerical ranges, including the end-points of these ranges.

A mean particle size (d50) of the carbonated supplementary cementitious cement after completion of the plurality of milling cycles may be from about 1 μm to about 25 μm, from about 2 μm to about 25 μm, from about 4 μm to about 24 μm, from about 6 μm to about 24 μm, from about 7 μm to about 23 μm, from about 8 μm to about 22 μm, from about 9 μm to about 21 μm, from about 10 μm to about 20 μm, and the like. The mean particle size (d50) can be equal to any integer value or values within any of the above-described numerical ranges, including the end-points of these ranges. Particle sizes described in this application are measured using a laser diffraction particle size analyzer.

A BET surface area of the carbonated supplementary cementitious material prepared according to the method described in this application is from about 5 m²/g to about 25 m²/g, about 5 m²/g to about 20 m²/g, about 5 m²/g to about 18 m²/g, about 5 m²/g to about 15 m²/g, about 6 m²/g to about 15 m²/g, about 7 m²/g to about 15 m²/g, about 8 m²/g to about 15 m²/g, about 9 m²/g to about 15 m²/g, and the like. The BET surface area can be equal to any integer value or values within any of the above-described numerical ranges, including the end-points of these ranges. A nitrogen adsorption method is used to measure the BET surface area described in this application.

The gas used for carbonation may comprise from about 5% to about 100% carbon dioxide, from about 10% to about 100%, from about 20% to about 100%, from about 30% to about 100%, from about 40% to about 100%, from about 50% to about 100%, from about 60% to about 100%, from about 70% to about 100%, from about 80% to about 100%, from about 90% to about 100%, by volume. The carbon dioxide content can be equal to any integer value or values within any of these ranges, including the end-points of these ranges.

The gas comprising carbon dioxide may be obtained from a flue gas. However, the gas comprising carbon dioxide is not limited thereto and any suitable source of gas containing carbon dioxide can be used. For example, a number of suppliers of industrial gases offer tanked carbon dioxide gas, compressed carbon dioxide gas and liquid carbon dioxide, in a variety of purities. Alternatively, the carbon dioxide can be recovered as a byproduct from any suitable industrial process. As used herein, a source of carbon dioxide from the byproduct of an industrial process will be generally referred to as “flue gas.” The flue gas may optionally be subject to further processing, such as purification, before being introduced into the carbonatable material. By way of non-limiting examples, the carbon dioxide can be recovered from a cement plant, power plant, etc.

A flow rate of the gas comprising carbon dioxide, as measured with a gas flow meter or calibrated valve, is from about 1 L/min to about 10 L/min, from about 1.5 L/min to about 9 L/min, from about 2 L/min to about 8 L/min, from about 2.5 L/min to about 7 L/min, from about 3 L/min to about 6 L/min, per kilogram of carbonatable material, and the like. The flow rate can be equal to any integer value or values within any of these ranges, including the end-points of these ranges.

The carbonation process can include flowing carbon dioxide for about 0.5 hours to about 24 hours, for about 1 hour to about 24 hours, for about 1.5 hours to about 20 hours, for about 2 hours to about 15 hours, for about 5 hours to about 10 hours, for about 4 hours to about 6 hours, and the like. The time of flowing the gas can be equal to any integer value or values within any of these ranges, including the end-points of these ranges.

The gas comprising carbon dioxide may be flowed over the carbonatable material at a temperature of about 1° C. to about 99° C., about 5° C. to about 90° C., about 10° C. to about 85° C., about 20° C. to about 80° C., about 30° C. to about 70° C., and the like. The temperature can be equal to any integer value or values within any of these ranges, including the end-points of these ranges.

One or more additives may be added to the carbonatable material, such as: a dispersing agent such as polycarboxylate ether (PCE), sugars, etc.; set retarding agents such as sugars, citric acids and its salts; carbonation enhancing additives such as acetic acid and its salts, vinegar, and the like.

The plurality of milling cycles can be carried out in a ball mill, a vertical roller mill, a belt roller mill, a granulator, a hammer mill, an attrition mill, a milling roller, a peeling roller mill, an air-swept roller mill, or a combination thereof, but the apparatus is not limited thereto, and any suitable apparatus may be used.

A predetermined temperature of the carbonatable material may be about 50° C. to about 150° C., about 55° C. to about 145° C., about 60° C. to about 140° C., about 65° C. to about 130° C., about 70° C. to about 120° C., about 75° C. to about 125° C., about 85° C. to about 115° C., and the like. The temperature can be equal to any integer value or values within any of these ranges, including the end-points of these ranges.

A starting liquid to solid ratio (L/S) of a mixture comprising the carbonatable material and water may be about 0.01 to about 2.5, about 0.01 to about 2.0, about 0.02 to about 1.5, about 0.03 to about 1.0, about 0.04 to about 0.09, about 0.05 to about 0.8, about 0.05 to about 0.6, about 0.05 to about 0.45, about 0.1 to about 0.25, and the like. The L/S ratio can be equal to any integer value or values within any of these ranges, including the end-points of these ranges.

The CO₂ uptake of the carbonated supplementary cementitious material prepared using this method can be from about 5% to about 40%, from about 8% to about 35%, from about 10% to about 30%, from about 12% to about 25%, from about 14% to about 20%, from about 16% to about 18%, and the like, where the CO₂ uptake is measured as a percentage change in mass of the cement after carbonation. The carbon dioxide uptake can be equal to any integer value or values within any of these ranges, including the end-points of these ranges.

In accordance with exemplary embodiments of the present invention, the carbonatable material can be formed from a first raw material having a first concentration of M mixed and reacted with a second raw material having a second concentration of Me to form a reaction product that includes at least one synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}·(H₂O)ₑ, wherein M is at least one metal that can react to form a carbonate and Me is at least one element that can form an oxide during the carbonation reaction.

As stated, the M in the first raw material may include any metal that can carbonate when present in the synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}·(H₂O)ₑ. For example, the M may be any alkaline earth element, preferably calcium and/or magnesium. The first raw material may be any mineral and/or byproduct having a first concentration of M.

As stated, the Me in the second raw material may include any element that can form an oxide by a hydrothermal disproportionation reaction when present in the synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}·(H₂O)ₑ. For example, the Me may be silicon, titanium, aluminum, phosphorus, vanadium, tungsten, molybdenum, gallium, manganese, zirconium, germanium, copper, niobium, cobalt, lead, iron, indium, arsenic, sulfur and/or tantalum. In a preferred embodiment, the Me includes silicon. The second raw material may be any one or more minerals and/or byproducts having a second concentration of Me.

In accordance with the exemplary embodiments of the present invention, the first and second concentrations of the first and second raw materials are high enough that the first and second raw materials may be mixed in predetermined ratios to form a desired synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}·(H₂O)ₑ, wherein the resulting synthetic formulation can undergo a carbonation reaction. In one or more exemplary embodiments, synthetic formulations having a ratio of a:b between approximately 2.5:1 to approximately 0.167:1 undergo a carbonation reaction. The synthetic formulations can also have an O concentration of c, where c is 3 or greater. In other embodiments, the synthetic formulations may have an OH concentration of d, where d is 1 or greater. In further embodiments, the synthetic formulations may also have a H₂O concentration of e, where e is 0 or greater.

The synthetic formulation reacts with carbon dioxide in a carbonation process, whereby M reacts to form a carbonate phase and the Me reacts to form an oxide phase by hydrothermal di sproportionation.

In an example, the M in the first raw material includes a substantial concentration of calcium and the Me in the second raw material contains a substantial concentration of silicon. In an exemplary embodiment, the first raw material can include the M in an amount of about 30% to about 60%, and the like, and the second raw material can include the Me in an amount of about 30% to about 60%, and the like. The carbon dioxide uptake can be equal to any integer value or values within any of these ranges, including the end-points of these ranges.

Thus, for example, the first raw material may be or include limestone, which has a first concentration of calcium. The second raw material may be or include shale, which has a second concentration of silicon. The first and second raw materials are then mixed and reacted at a predetermined ratio to form reaction product that includes at least one synthetic formulation having the general formula (Ca_{w}Mₓ)ₐ(Si_{y}Me_{z})_{b}O_{c}, (Ca_{w}Mₓ)ₐ(Si_{y},Me_{z})_{b} (OH)_{d}, or (Ca_{w}Mₓ)ₐ (Si_{y},Me_{z})_{b} O_{c}(OH)_{d}·(H₂O)ₑ, wherein M may include one or more additional metals other than calcium that can react to form a carbonate and Me may include one or more elements other than silicon that can form an oxide during the carbonation reaction. The limestone and shale in this example may be mixed in a ratio a:b such that the resulting synthetic formulation can undergo a carbonation reaction as explained above. The resulting synthetic formulation may be, for example, wollastonite, CaSiO₃, having a 1:1 ratio of a:b. However, for synthetic formulation where M is mostly calcium and Me is mostly silicon, it is believed that a ratio of a:b between approximately 2.5:1 to approximately 0.167:1 may undergo a carbonation reaction because outside of this range there may not be a reduction in greenhouse gas emissions and the energy consumption or sufficient carbonation may not occur. For example, for a:b ratios greater than 2.5:1, the mixture would be M-rich, requiring more energy and release of more CO₂. Meanwhile for a:b ratios less than 0.167:1, the mixture would be Me-rich and sufficient carbonation may not occur.

In another example, the M in the first raw material includes a substantial concentration of calcium and magnesium. Thus, for example, the first raw material may be or include dolomite, which has a first concentration of calcium, and the synthetic formulation have the general formula (MgᵤCaᵥM_{w})ₐ (Si_{y},Me_{z})_{b}O_{c} or (MgᵤCaᵥM_{w})ₐ (Si_{y}Me_{z})_{b}(OH)_{d}, wherein M may include one or more additional metals other than calcium and magnesium that can react to form a carbonate and Me may include one or more elements other than silicon that can form an oxide during the carbonation reaction. In another example, the Me in the first raw material includes a substantial concentration of silicon and aluminum and the synthetic formulations have the general formula (CaᵥM_{w})ₐ(AlₓSi_{y},Me_{z})_{b}O_{c} or (CaᵥM_{w})ₐ(AlₓSi_{y},Me_{z})_{b}(OH)_{d}, (CaᵥM_{w})ₐ(AlₓSi_{y},Me_{z})_{b}O_{c} (OH)_{d}, or (CaᵥM_{w})ₐ(AlₓSi_{y},Me_{z})_{b}O_{c} (OH)_{d}·(H₂O)ₑ.

Compared to Portland cement, which has an a:b ratio of approximately 2.5:1, the exemplary synthetic formulations of the present invention result in reduced amounts of CO₂ generation and require less energy to form the synthetic formulation, which is discussed in more detail below. The reduction in the amounts of CO₂ generation and the requirement for less energy is achieved for several reasons. First, less raw materials, such as limestone for example, is used as compared to a similar amount of Portland Cement so there is less CaCO₃ to be converted. Also, because fewer raw materials are used there is a reduction in the heat (i.e. energy) necessary for breaking down the raw materials to undergo the carbonation reaction.

Other specific examples of carbonatable materials consistent with the above are described in U.S. Pat. No. 9,216,926 and U.S. provisional application No. 63/151,971, and corresponding U.S. application Ser. No. 17/675,777, which are incorporated herein by reference in their entirety.

According to further embodiments, the carbonatable material comprises, consists essentially of, or consists of various calcium silicates. The molar ratio of elemental Ca to elemental Si in the composition is from about 0.8 to about 1.2. The composition is comprised of a blend of discrete, crystalline calcium silicate phases, selected from one or more of CS (wollastonite or pseudowollastonite), C3 S2 (rankinite) and C2S (belite or larnite or bredigite), at about 30% or more by mass of the total phases. The calcium silicate compositions are characterized by having about 30% or less of metal oxides of Al, Fe and Mg by total oxide mass, and being suitable for carbonation with CO₂ at a temperature of about 30° C. to about 95° C., or about 30° C. to about 70° C., to form CaCO₃ with mass gain of about 10% or more. The calcium silicate composition may also include small quantities of C3S (alite, Ca₃SiO₅). The C2S phase present within the calcium silicate composition may exist in any α-Ca₂SiO₄, β-Ca₂SiO₄ or γ-Ca₂SiO₄ polymorph or combination thereof. The calcium silicate compositions may also include small quantities of residual CaO (lime) and SiO₂ (silica).

Calcium silicate compositions may contain amorphous (non-crystalline) calcium silicate phases in addition to the crystalline phases described above. The amorphous phase may additionally incorporate Al, Fe and Mg ions and other impurity ions present in the raw materials. Each of these crystalline and amorphous calcium silicate phases is suitable for carbonation with CO₂. The calcium silicate compositions may also include small quantities of residual CaO (lime) and SiO₂ (silica).

Each of these crystalline and amorphous calcium silicate phases is suitable for carbonation with CO₂.

The calcium silicate compositions may also include quantities of inert phases such as melilite type minerals (melilite or gehlenite or akermanite) with the general formula (Ca,Na,K)₂[(Mg, Fe²⁺, Fe³⁺, Al, Si)₃O₇] and ferrite type minerals (ferrite or brownmillerite or C₄AF) with the general formula Ca₂(Al, Fe³⁺)₂O₅. In certain embodiments, the calcium silicate composition is comprised only of amorphous phases. In certain embodiments, the calcium silicate comprises only crystalline phases. In certain embodiments, some of the calcium silicate composition exists in an amorphous phase and some exists in a crystalline phase.

Each of these calcium silicate phases is suitable for carbonation with CO₂. Hereafter, the discrete calcium silicate phases that are suitable for carbonation will be referred to as reactive phases. The reactive phases may be present in the composition in any suitable amount. In certain preferred embodiments, the reactive phases are present at about 50% or more by mass.

The various reactive phases may account for any suitable portions of the overall reactive phases. In certain preferred embodiments, the reactive phases of CS are present at about 10 to about 60 wt %; C₃S₂ in about 5 to 50 wt %; C₂S in about 5 wt % to 60 wt %; C in about 0 wt % to 3 wt %. The amount of the reactive phases of CS can be equal to any integer value or values within any of these ranges, including the end-points of these ranges.

In certain embodiments, the reactive phases comprise a calcium-silicate based amorphous phase, for example, at about 40% or more, about 45% or more, about 50% or more, about 55% or more, about 60% or more, about 65% or more, about 70% or more, about 75% or more, about 80% or more, about 85% or more, about 90% or more, about 95% or more, and the like, by mass of the total phases. It is noted that the amorphous phase may additionally incorporate impurity ions present in the raw materials. The percentage of the amorphous phase can be equal to any integer value or values within any of these ranges, including the end-points of these ranges.

It should be understood that, calcium silicate compositions, phases and methods disclosed herein can be adopted to use magnesium silicate phases in place of or in addition to calcium silicate phases. As used herein, the term “magnesium silicate” refers to naturally-occurring minerals or synthetic materials that are comprised of one or more of a groups of magnesium-silicon-containing compounds including, for example, Mg₂SiO₄ (also known as “forsterite”) and Mg₃Si₄O₁₀ (OH)₂ (also known as “talc”) and CaMgSiO₄ (also known as “monticellite”), each of which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by weight.

Other specific examples of carbonatable calcium silicate materials consistent with the above are described in U.S. Pat. No. 10,173,927, which is incorporated herein by reference in its entirety.

Additionally, a cementitious material can include calcium silicate, calcium carbonate and amorphous silica. The amorphous silica content can be about 5% to about 50%, about 8% to about 45%, about 8% to about 40%, about 9% to about 40%, about 10% to about 40%, about 20% to about 40%, by mass, and the amorphous silica is reactive with calcium hydroxide to form calcium silicate hydrate gel. The amorphous silica content can be equal to any integer value or values within any of these ranges, including the end-points of these ranges.

The cement or concrete described herein can comprise a plurality of bonding elements, each of the bonding elements comprising: a core (uncarbonated cement); a silica-rich first layer at least partially covering a peripheral portion of the core; and a calcium carbonate and/or magnesium carbonate-rich second layer at least partially covering a peripheral portion of the first layer. As used herein, the terms “silica-rich” and “calcium carbonate and/or magnesium carbonate-rich” may mean a silica and calcium carbonate and/or magnesium carbonate content, respectively, that is greater than 50% by weight or volume of the total mass or volume of the constituents of the respective layer.

The silica-rich first layer may comprise amorphous silica. The amount of amorphous silica in the silica-rich layer may be higher than an amount of amorphous silica in a cement or concrete prepared without curing the mixture in a Ca(OH)₂ solution.

The silica-rich layer may further react with Ca(OH)₂ produced from ordinary Portland cement (OPC) hydration to form additional C—S—H (pozzolanic reaction), and the calcium carbonate from the supplementary cementitious material reacts with OPC to form monocarbonate.

The carbonatable material may comprise calcium silicate having a molar ratio of elemental Ca to elemental Si of about 0.5 to about 1.5, about 0.6 to about 1.4, about 0.7 to about 1.3, about 0.8 to about 1.2, about 0.9 to about 1.1, and the like. The molar ratio can be equal to any integer value or values within any of these ranges, including the end-points of these ranges.

The carbonatable material may comprise a blend of discrete, crystalline calcium silicate phases, selected from one or more of CS (wollastonite or pseudowollastonite), C₃S₂ (rankinite) and C₂S (belite or larnite or bredigite), at about 20% or more, preferably about 25% or more, about 30% or more, about 35% or more, about 40% or more, about 45% or more, about 50% or more, about 55% or more, about 60% or more, about 65% or more, about 70% or more, about 75% or more, about 80% or more, about 85% or more, about 90% or more, and the like, and may be about 99% or less, about 98% or less, about 97% or less, about 96% or less, about 95% or less, and the like, by mass of the total phases. The blend of discrete, crystalline calcium silicate phases may also include about 50% or less, about 45% or less, about 40% or less, about 35% or less, about 30% or less, about 25% or less, about 20% or less, about 15% or less, about 10% or less, about 5% or less, and the like, of metal oxides of Al, Fe and Mg by total oxide mass. The amount of the blend of discrete, crystalline calcium silicate phases can be equal to any integer value or values within any of these ranges, including the end-points of these ranges. The carbonatable material may further comprise an amorphous calcium silicate phase.

Other non-limiting examples of supplementary cementitious material, methods of producing same, and the incorporation thereof in ordinary Portland cement and the like, consistent with the above are described in U.S. provisional Application No. 63/217,574, and corresponding US application No. 17/854,778, which is incorporated herein by reference in its entirety.

Still further, the pozzolanic reaction described above includes a “pozzolan”, which broadly encompasses siliceous or alumino-siliceous and aluminous materials which do not possess any intrinsic cementitious properties, but may chemically react (or be activated) with calcium hydroxide in the presence of water to form cementitious compounds. We also refer to pozzolan material as an activatable amorphous phase. Historically, naturally occurring materials containing a volcanic glass component were used in combination with slaked lime to create the mortars integral to ancient construction practices. In modern times, a large number of pozzolanic materials are used in conjunction with hydraulic cements. These include materials such as fly ash, ground granulated blast furnace slag (GGBFS), silica fume, burned organic residues (for example, rice husk ash), reactive metakaolin (calcined clays), calcined shales, volcanic ash, pumice and diatomaceous earth.

A decrease in the embodied CO₂ footprint of concrete products has been made possible across many applications through the use of such pozzolans, which encompass a range of natural materials and industrial by-products that possess the ability to replace a proportion of Portland cement in a concrete while still contributing to the strength of the final concrete member. Since these materials contribute to the strength of the material, they are able to replace a substantial amount of Portland cement, in some cases up to 80%.

The reaction of a pozzolan in a typical hydraulic cement system is simply the reaction between portlandite (Ca(OH)₂), supplied by the hydraulic cement component, and silicic acid (H₄SiO₄). This reaction creates a compound generally referred to as calcium silicate hydrate (C—S—H), generally written as CaH₂SiO₄·2H₂O. In practice, the CSH phase can have a highly variable Ca/Si molar ratio and a highly variable crystalline water content. Further details of the pozzolanic reaction are described in U.S. Pat. No. 10,662,116, which is incorporated herein by reference in its entirety.

Another exemplary embodiment is directed to a method for forming cement or concrete, the method comprising: forming a carbonated supplementary cementitious material according to any of the exemplary method described herein; combining the carbonated supplementary cementitious material with a hydraulic cement composition to form a mixture, wherein the mixture comprises about 1% to about 99%, by weight, of the carbonated supplementary cementitious material, based on the total weight of solids in the mixture; and reacting the mixture with water to form the cement or concrete. The mixture may comprise about 20% to about 35% of the carbonated supplementary cementitious material by weight, based on the total weigh of solids in the mixture. The amount of the various components of the mixture can be equal to any integer value or values within any of these ranges, including the end-points of these ranges. The hydraulic cement may comprise one or more of ordinary Portland cement (OPC), calcium sulfoaluminate cement (CSA), belitic cement, or other calcium based hydraulic material. This method may further comprise adding an aggregate to the mixture, and the aggregate may be coarse and/or fine aggregates. The resulting cement or concrete may be suitable for various applications, including but not limited to foundations, road beds, sidewalks, architectural slabs, pavers, CMUs, wet cast tiles, segmented retaining walls, hollow core slabs, and other cast and pre-cast applications. The resulting cement or concrete may also be suitable for use in the preparation of a mortar appropriate for masonry applications.

Other non-limiting examples of the carbonatable calcium silicate material and additional details of the supplementary cementitious material, and the incorporation thereof in ordinary Portland cement and the like, consistent with the above are described in U.S. provisional application No. 63/151,971, and corresponding U.S. application Ser. No. 17/675,777, which is incorporated herein by reference in its entirety.

A strength activity index (SAI) of the cement or concrete prepared using any of the methods described in this application can be at least about 50%, from about 50% to about 150%, from about 55% to about 145%, from about 60% to about 140%, from about 65% to about 135%, from about 70% to about 130%, from about 75% to about 120%, and the like, where the SAI is measured according to ASTM C618 at 20% replacement of OPC in a mortar mix. The strength activity index is a ratio of a compressive strength of the cement or concrete comprising about 20% by weight of the carbonated supplementary cementitious material to a compressive strength of the cement or concrete comprising about 0% by weight of the carbonated supplementary cementitious material, based on the total weight of solids in the mixture. The strength activity index can be equal to any integer value or values within any of these ranges, including the end-points of these ranges. The strength activity index of the cement or concrete measured at 28 days or more after formation of the cement or concrete can be higher than the strength activity index of the cement or concrete measured at 7 days or less after formation of the cement or concrete. The strength activity index of the cement or concrete prepared using a carbonated supplementary cementitious material after grinding is higher than a strength activity index of the cement or concrete prepared using a carbonated supplementary cementitious material without grinding.

When the milling of a carbonated cementitious material is carried out for about 5 minutes to about 10 minutes, a strength activity index of the cement or concrete measured at about 7 days after formation of the cement or concrete is about 5% to about 20%, about 6% to about 18%, about 7% to about 16%, about 7.5% to about 14%, about 8% to about 13%, about 8.5% to about 13%, about 9% to about 12%, and the like, higher than the strength activity index of the cement or concrete measured at 7 days after formation of the cement or concrete without milling the carbonated cementitious material.

As shown by the results of the Examples of this application, intermediate milling, whereby a carbonated cementitious material is milled prior to further carbonation, increases the CO2 uptake as well as activates the amorphous silica in the silica-rich layer and drives the pozzolanic reaction between the silica-rich layer and the Ca(OH)₂ produced from ordinary Portland cement (OPC) hydration to form additional C—S—H. This results in the cement or concrete having unexpectedly high Strength Activity Index, which is maintained and/or increases with time.

The principles of the present invention, as well as certain exemplary features and embodiments thereof, will now be described by reference to the following non-limiting examples.

### Examples

Materials Processing—Steaming

One example of materials processing includes steaming. In this method, a steamer is pre-heated to a predetermined temperature, which ranges from 30° C. to 90° C. Samples including 10.0 g of a carbonatable powder material and 2.0 g tap water (L/S ratio=0.20) are mixed well by kneading in a plastic zip-top bag for about a minute, followed by quickly placing small pieces of the mix into aluminum pans with a known tare. The pans are placed on a metal tray and inset into the steamer with a cone placed on top. Steaming is carried out at a temperature of 68° C., and CO₂ pressure of 3 psi. The carbonation time is 60 minutes at a fan speed of 400 rpm. The samples are dried overnight at 80° C.

Materials Processing—Stirring

Another example of materials processing includes stirring. In this method, 250 g of carbonated powder (solid) is milled for 5 minutes in a planetary ball mill, and mixed with 582.5 g of tap water to prepare a mixture having an L/S ratio=2.33. The mixture is stirred at 400 rpm with a Rushton impeller at a temperature of 60° C. for 1 hr under a 100% CO₂ flow rate of 1552 mL/min. At the end of the carbonation process, the slurry is filtered using a membrane, and the wet cake is dried overnight at 80° C.

Effect of Grinding Solidia SCM

Carbonated Solidia SCM was produced using a slurry carbonation process and dried to make dry Solidia SCM. Six such batches of SCM were produced and characterized. To avoid any batch-to-batch variation influencing the performance evaluation all six batches produced were blended at a 3rd party blending facility (Empire Blending “EB”). The blended material of Examples 1 to 3 were milled in a Retch planetary ball mill for 1, 5 and 10 minutes, respectively, followed by measurement of the mortar performance of the blended materials. Table 1 shows the particle size distribution and surface area measured using a BET method for the pre-milling blended material (EB1, Comparative Example 1), and the milled blended material of Examples 1 to 3:

TABLE 1

| | | Milling | | | | |
|---|---|---|---|---|---|---|
| | | Time | d10 | d50 | d90 | BET SSA |
| | Sample | (minutes) | (μm) | (μm) | (μm) | (m²/g) |
| Comparative | EB1 | 0 | 3.39 | 8.49 | 45.30 | 9.34 |
| Example 1 | | | | | | |
| Example 1 | EB1 | 1 | 0.181 | 7.86 | 44.67 | 10.15 |
| Example 2 | EB1 | 5 | 0.285 | 13.66 | 55.38 | 11.62 |
| Example 3 | EB1 | 10 | 0.174 | 11.56 | 51.88 | 14.76 |

As shown in Table 1, milling produces a much finer material, which results in a corresponding increase in the BET surface area.

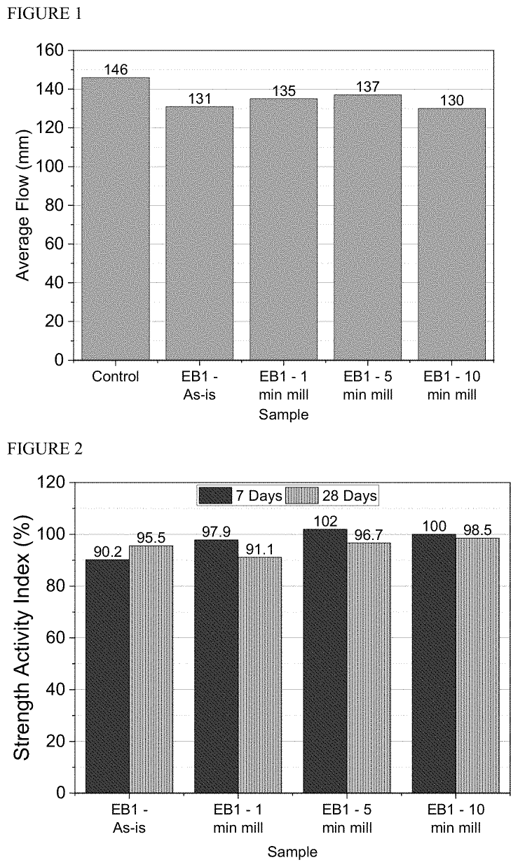

Table 2 summarizes the mortar flow and compressive strength performance at 20% replacement (0.485 water-to-cement ratio) of ordinary Portland cement (OPC) (20% EB1 blend, Comparative Example 2), and 20% EB1 milled for 1, 5, and 10 minutes (Examples 4-6, respectively). The flow data, measured according to ASTM C230, is shown in FIG. 1, and the SAI data, measured according to ASTM C618, is shown in FIG. 2.

TABLE 2

| | | Milling | Flow | 7 Day | 28 Day |
|---|---|---|---|---|---|
| | | Time | Drop | SAI | SAI |
| | Sample | (minutes) | (%) | (%) | (%) |
| Comparative | 20% EB1 | 0 | 10.29 | 90.18 | 95.51 |
| Example 2 | | | | | |
| Example 4 | 20% EB1 | 1 | 7.53 | 97.86 | 91.11 |
| Example 5 | 20% EB1 | 5 | 6.85 | 101.97 | 93.66 |
| Example 6 | 20% EB1 | 10 | 10.96 | 100.03 | 98.52 |

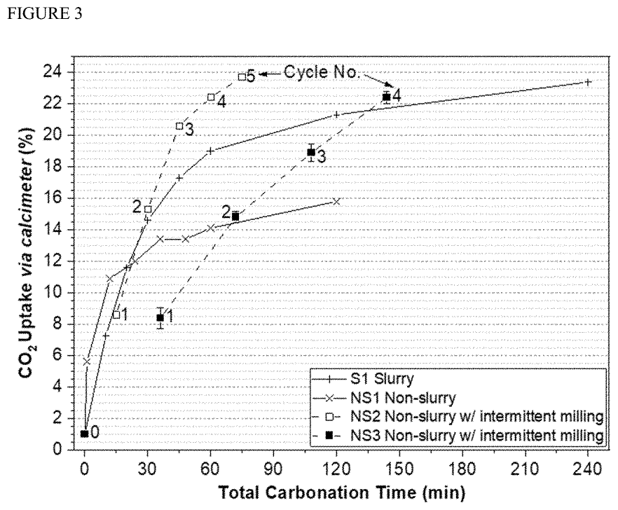

As shown in Table 2, there is no further increase in water demand with grinding of the supplementary cementitious material up to 5 minutes, and the strength activity index increases by about 10% with grinding. The CO₂ uptake of these materials was measured with a calcimeter, and are shown in Table 3 and FIG. 3.

TABLE 3

| | | | | | | Total | |
|---|---|---|---|---|---|---|---|
| | | | Milling | | Number of | Carbonation | CO₂ |
| | | Carbonation | Time | | Carbonation | Time | Uptake |
| | Sample | Method | (minutes) | Processing | Cycles | (minutes) | (wt %) |
| Ex. 7 | EB1 | Slurry | N/A | As-is, | 0 | 240 | 23.45 |
| | | | | milling | | | |
| Ex. 8 | S1 | Slurry | N/A | N/A | 0 | 240 | 23.38 |
| Ex. 9 | NS1 | Non-slurry | N/A | N/A | 0 | 120 | 15.8 |
| Ex. 10 | NS2-0 | Non-slurry | N/A | N/A | 0 | 0 | 1 |
| Ex. 11 | NS2-1 | Non-slurry | 0 | N/A | 1 | 15 | 8.6 |
| Ex. 12 | NS2-2 | Non-slurry | 0 | N/A | 2 | 30 | 9.72 |
| Ex. 13 | NS2-3 | Non-slurry | 5 | Intermittent | 2 | 30 | 15.3 |
| | | | | Milling | | | |
| Ex. 14 | NS2-4 | Non-slurry | 5 | Intermittent | 3 | 45 | 20.6 |
| | | | | Milling | | | |
| Ex. 15 | NS2-5 | Non-slurry | 5 | Intermittent | 4 | 60 | 22.4 |
| | | | | Milling | | | |
| Ex. 16 | NS2-6 | Non-slurry | 5 | Intermittent | 5 | 75 | 22.4 |
| | | | | Milling | | | |
| Ex. 17 | NS3-1 | Non-slurry | 0 | N/A | 1 | 36 | 8.4 |
| Ex. 18 | NS3-2 | Non-slurry | 5 | Intermittent | 2 | 72 | 14.8 |
| | | | | Milling | | | |
| Ex. 19 | NS3-3 | Non-slurry | 5 | Intermittent | 3 | 108 | 18.9 |
| | | | | Milling | | | |
| Ex. 20 | NS3-4 | Non-slurry | 6 | Intermittent | 4 | 144 | 22.4 |
| | | | | Milling | | | |

As shown in FIG. 3, the CO₂ uptake significantly increases when multiple milling cycles are carried out. For example, as shown in Table 3, the CO₂ uptake increases by about 125% after multiple milling cycles, for a total carbonation time of 75 minutes.

The results shown in Table 3 and FIG. 3 also demonstrate that grinding between carbonation steps increases the CO₂ uptake over a short amount of time. For example, as shown in Table 3 (Examples 12 and 13), about 5% increase in CO₂ uptake is achieved by milling for 5 minutes.

As described above, the carbonated SCM used in these examples was created using a slurry carbonation process. In this process, a slurry of the carbonatable material and water was dried in a tray. Further details of the slurry process are described in U.S. provisional application No. 63/151,971, and corresponding U.S. application Ser. No. 17/675,777, the contents of which are incorporated by reference as if fully set forth herein. The dried powder further milled for 1, 5, and 10 minutes. The as—is dried material and milled materials were replaced at 20 wt % for OPC in a mortar mix to evaluate the impact of grinding in flow and strength development. TABLE 2 shows the flow performance of milled EB samples. Also shown in TABLE 2 (Example 5), the 7-day strength activity index (SAI) increases substantially from about 90% (20% EB without milling) to about 98% after 1 minute of milling, and over 100% when milled for 5 minutes or more.

Material Characterization

The particle size distribution and surface area of the materials are measured using laser diffraction and BET method, respectively, for the initial and processed materials. The particle size and surface area measurements are shown in TABLE 1. The characteristics of an SCM prepared using a slurry method are also included in TABLE 1 (Comparative Example 1).

Mortar Performance—Flow Measurements

Mortar (mixture of ASTM sand and cementitious material) flow was measured at 20% (w/c 0.485) replacement levels of OPC with ASTM C109 proportion of cement and sand. FIG. 1 shows the flow with the ground material. No increase in water demand was observed at 20%, 35% and 50% replacement levels to match the flow of 100% OPC mortar.

Mortar Performance—Compressive Strength

Mortars made for flow were also cast for compressive strength measurements. FIG. 2 shows the strength activity index (SAI) of the mortar. SAI is a ratio of compressive strength of SCM mortar at 20% replacement and compressive strength of mortar made with 100% OPC. All mortar cubes are cast in a controlled temperature and humidity environment.

Solidia SCM produced by the carbonation process described in this application, which includes at least one milling cycle, had surface area much lower than SCM produced using a slurry process. Grinding the material resulted in improvement in strength activity index at 28 days. Despite a lower surface area, the strength activity index of the ground material was on-par with the SCM produced using the slurry process.

As various changes could be made in the above methods and compositions without departing from the scope of the invention, it is intended that all matter contained in the above description shall be interpreted as illustrative and not in a limiting sense. Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

We claim:

1. A method of preparing a carbonated supplementary cementitious material, the method comprising:
adding water to a carbonatable material to form a carbonatable mixture, wherein a moisture content of the mixture is from about 0.1% to about 99.99% by weight;
agitating or stirring the carbonatable mixture for about 1 minute to about 24 hours;
carbonating the carbonatable mixture to obtain a first carbonated cementitious material;
milling the first carbonated cementitious material for about 0.1 minute to about 60 minutes to obtain a milled mixture; and
carbonating the milled mixture for about 1 minute to about 24 hours to obtain the carbonated supplementary cementitious material,
wherein carbonating the carbonatable mixture and the milled mixture comprises flowing a gas comprising about 5% to about 100% carbon dioxide, by volume, into the carbonatable mixture and the milled mixture, respectively, and maintaining a temperature of about 1° C. to about 99° C., to obtain the carbonated supplementary cementitious material.

2. The method of claim 1, wherein the moisture content of the carbonatable mixture is about 0.1% to about 90% by weight.

3. The method of claim 1, wherein the method comprises a plurality of carbonation cycles alternating with a plurality of milling and wetting cycles.

4. The method of claim 1, further comprising steaming the milled mixture prior to carbonating the milled mixture, wherein the steaming comprises exposing the milled mixture to water vapor or steam at a temperature of about 20° C. to about 200° C.

5. The method of claim 1, further comprising drying the carbonated supplementary cementitious material for about 1 minute to about 24 hours at a temperature of about 20° C. to about 500° C.

6. The method of claim 1, further comprising de-agglomerating the mixture.

7. The method of claim 1, further comprising obtaining the gas comprising carbon dioxide from a flue gas.

8. The method of claim 1, wherein the milling is carried out in a mill selected from a ball mill, a vertical roller mill, a belt roller mill, a granulator, a hammer mill, attrition mill, a milling roller, a peeling roller mill, an air-swept roller mill, or a combination thereof.

9. The method of claim 1, further comprising moistening the gas prior to carbonating, wherein moistening the gas comprises bubbling the gas through hot water.

10. The method of claim 1, wherein a flow rate of the gas comprising carbon dioxide is from about 1 L/min/Kg to about 6 L/min/Kg per kilogram of carbonatable material.

11. The method of claim 1, wherein the flowing of the gas comprising carbon dioxide is carried out for about 1 min to about 24 hours.

12. The method of claim 1, wherein a mean particle size (d50) of the carbonated supplementary cementitious material is from about 1 μm to about 25 μm.

13. The method of claim 1, wherein a BET surface area of the carbonated supplementary cementitious material is from about 5 m²/g to about 25 m²/g.

14. The method of claim 1, wherein a carbon dioxide uptake of the carbonated supplementary cementitious material is from about 5% to about 40%.

15. The method of claim 1, wherein the carbonatable material includes at least one synthetic formulation having the general formula MₐMe_{b}O_{c}, MₐMe_{b}(OH)_{d}, MₐMe_{b}O_{c}(OH)_{d} or MₐMe_{b}O_{c} (OH)_{d}·(H₂O)ₑ, wherein M is at least one metal that can react to form a carbonate and Me is at least one element that can form an oxide during the carbonation reaction.

16. The method of claim 15, wherein M is calcium and/or magnesium.

17. The method of claim 15, wherein Me is silicon, titanium, aluminum, phosphorus, vanadium, tungsten, molybdenum, gallium, manganese, zirconium, germanium, copper, niobium, cobalt, lead, iron, indium, arsenic, sulfur and/or tantalum.

18. The method of claim 15, wherein a ratio of a:b is about 2.5:1 to about 0.167:1, c is 3 or greater, d is 1 or greater, e is 0 or greater.

19. The method of claim 1, wherein the carbonatable material comprises calcium silicate having a molar ratio of elemental Ca to elemental Si of about 0.8 to about 3.0.

20. The method of claim 19, wherein the carbonatable material comprises a blend of discrete, crystalline calcium silicate phases, selected from one or more of CS (wollastonite or pseudowollastonite), C₃S₂ (rankinite) and C₂S (belite or larnite or bredigite), at about 30% or more by mass of the total phases, and about 30% or less of metal oxides of Al, Fe and Mg by total oxide mass.

21. The method of claim 19, wherein the carbonatable material comprises a calcium silicate hydrate (C—S—H), recycled concrete, municipality waste, mine tailings, or a mixture thereof.

22. The method of claim 15, wherein the carbonatable material further comprises an amorphous calcium silicate phase.

23. A method for forming cement or concrete, the method comprising:
forming a carbonated supplementary cementitious material according to the method of claim 1;
combining the carbonated supplementary cementitious material with a hydraulic cement composition to form a cementitious material mixture, wherein the cementitious material mixture comprises about 1% to about 99%, by weight, of the carbonated supplementary cementitious material, based on the total weight of solids in the mixture; and
reacting the cementitious material mixture with water to form the cement or concrete.

24. The method of claim 23, wherein the cementitious material mixture comprises about 20% to about 35% of the carbonated supplementary cementitious material by weight, based on the total weigh of solids in the mixture.

25. The method of claim 23, wherein the hydraulic cement composition comprises one or more of ordinary Portland cement (OPC), calcium sulfoaluminate cement (CSA), belitic cement, or other calcium based hydraulic material.

26. The method of claim 23, further comprising adding aggregate to the cementitious material mixture.

27. The method of claim 23, wherein:
a strength activity index of the cement or concrete is from about 75% to about 120%, and
the strength activity index is a ratio of a compressive strength of the cement or concrete comprising about 20% by weight of the carbonated supplementary cementitious material to a compressive strength of the cement or concrete comprising about 0% by weight of the carbonated supplementary cementitious material, based on the total weight of solids in the mixture.

28. The method of claim 23, wherein:
the milling of the first carbonated cementitious material is carried out for about 5 minutes to about 60 minutes,
a strength activity index of the cement or concrete obtained after milling the first carbonated cementitious material is about 7% to about 15% higher than the strength activity index of a cement or concrete obtained without milling, when measured at 7 days after formation of the respective cement or concrete, and
the strength activity index is a ratio of a compressive strength of the cement or concrete comprising about 20% by weight of the carbonated supplementary cementitious material to a compressive strength of the cement or concrete comprising about 0% by weight of the carbonated supplementary cementitious material, based on the total weight of solids in the mixture.

29. The method of claim 28, wherein:
a strength activity index of the cement or concrete obtained after milling the first carbonated cementitious material for about 5 minutes to about 10 minutes is about 8.5% to about 13% higher than the strength activity index of the cement or concrete obtained without milling, when measured at 7 days after formation of the respective cement or concrete.

30. The method of claim 23, wherein:
a strength activity index of the cement or concrete measured at 28 days after formation of the cement or concrete is higher than the strength activity index of the cement or concrete measured at 7 days after formation of the cement or concrete, and
the strength activity index is a ratio of a compressive strength of the cement or concrete comprising about 20% by weight of the carbonated supplementary cementitious material to a compressive strength of the cement or concrete comprising about 0% by weight of the carbonated supplementary cementitious material, based on the total weight of solids in the mixture.
